(19) United States
(12) Patent Application Publication
(10) Pub. No.: US 2001/0038190 A1
(43) Pub. Date: Nov. 8, 2001

(54) Bicycle accessory

(76) Inventor: Alyn Provencher, Ste-Madeleine (CA)

Correspondence Address: Eric Fincham, 316 Knowlton Road, Lac Brome, QC, J0E 1V0, CA

(21) Appl. No.: 09/799,836

(22) Filed: Mar. 6, 2001

Related U.S. Application Data
(63) Continuation-in-part of application No. 09/272,001, filed on Mar. 18, 1999, now abandoned.

(30) Foreign Application Priority Data
Mar. 23, 1998 (GB) 9805978.5

(51) Int. Cl. B62K 27/12

(52) U.S. Cl. 280/281.1; 280/204

(57) ABSTRACT

A trailer assembly which is connectable to a bicycle, which bicycle has a seat mounted on a seat post, the trailer assembly comprising a frame having an upper portion and a lower portion with the upper portion being connected to the bicycle proximate the seat post, the connection permitting movement in both longitudinal and horizontal planes. The trailer includes an axle, a single wheel and a fork connected to the axle on either side of the wheel and baggage carrying means which include a frame and a connection between the frame and the fork, with the lower portion and the baggage carrying frame being connected together. The arrangement provides a trailer which may be suitable for many purposes including carrying baggage, child seats, and the like.

The present application is a Continuation-in-Part of application Ser. No. 09/272,001 filed Mar. 18, 1999.

### FIELD OF THE INVENTION

The present invention relates to bicycle accessories and more particularly, relates to a trailer suitable for attachment to a bicycle or the like.

### BACKGROUND OF THE INVENTION

There are many known bicycle trailers and attachments for bicycles. Many of these trailers are used for carrying children and/or other objects. For purposes of stability, most such trailers use a pair of wheels for supporting the carrying load.

While a duo wheel device performs the required tasks, it does suffer from a lack of maneuverability and requires a relatively wide structure that can be somewhat cumbersome when maneuvering on certain trails.

This problem has been recognized in the past and various single wheel trailer devices have been proposed. However, such devices have been relatively complex mechanically and have not always provided the features required by the user.

It would be desirable to have a single wheel trailer which can be used for carrying both cargo and small children. Preferably, it would be adaptable to be used for various tasks such as shopping, touring, trail riding, camping and the like in a variety of situations. The trailer should be of a relatively light weight. To minimize the rolling resistence, the trailer should be designed for relatively low aerodynamic drag and be of the single wheel type to reduce the rolling resistance.

It is also desirable to provide a trailer which is easily stored and can be attached and detached from the bicycle with a minimum of tools. Also, preferably the trailer is interchangeable among different uses again without the use of complex tools.

Thus, the trailer should be easily converted between different functions.

### SUMMARY OF THE INVENTION

According to one aspect of the present invention, there is provided a trailer assembly connectable to a bicycle having front and rear wheels and having a seat mounted on a seat post, the trailer assembly comprising a frame having an upper portion and a lower portion, a rearwardly extending member secured to the seat post, first connecting means connecting the upper portion to the rearwardly extending member, the first connecting means permitting movement in both a longitudinal and a horizontal plane, the first connecting means being located proximate a vertical plane extending through a hub of the rear wheel, a trailer, the trailer having an axle, a single wheel and a fork connected to the axle on either side of the wheel, baggage carrying means, the baggage carrying means comprising a baggage carrying frame, second connecting means extending between and connecting the baggage carrying frame and the fork, the second connecting means permitting rotatable movement between the baggage carrying frame and the fork such that the baggage carrying frame can be moved to a storage position and third connecting means extending between and connecting the lower portion and the baggage carrying frame.

The trailer assembly of the present invention, as aforementioned, comprises a mounting member which is adapted to be connected to the bicycle, a vehicle which is to be towed by the bicycle, and an interconnecting member extending between a distal end of the mounting member and the vehicle to be towed.

The mounting member is arranged to be connected to the bicycle proximate the seat post.

The vehicle to be towed by the bicycle preferably is in the form of a single wheeled trailer. In this embodiment, the single wheeled trailer may include a number of accessories for either transporting a child or goods. The trailer will preferably include standing means for support when in a stationary position.

In one embodiment, the trailer may be replaced by a sled type vehicle for travel on snow or ice.

Extending between the vehicle and the distal end of the mounting member is an interconnecting portion. In this respect, the end of the interconnecting portion which is attached to the mounting member is done so by means of a universal type of joint. The universal joint is situated substantially directly above the hub of the rear wheel of the bicycle—i.e. substantially in a vertical plane extending through the hub of the bicycle.

The interconnecting member, in the basic mode, comprises a rigid member which extends between the vehicle to be towed and the mounting member. However, the trailer assembly may include one or more additional modules which may be interposed between the interconnecting member and the vehicle to be towed. Such additional modules may be provided for purpose of transporting an additional child and/or other goods.

### BRIEF DESCRIPTION OF THE DRAWINGS

Having thus generally described the invention, reference will be made to the accompanying drawings illustrating different embodiments thereof, in which:

FIG. 1 is a side elevational view of a trailer assembly with a portion of the bicycle to which the trailer is attached being illustrated;

FIG. 2 is a side elevational view of the trailer assembly of FIG. 1 with an additional module;

FIG. 3 is a view of a modified version of the interconnecting member;

FIG. 4 is a plan view, partially in section, of a modified universal joint;

FIG. 5 is a side elevational view of the trailer assembly of FIG. 1 having a stand and an extra child seat;

FIG. 6 is a view taken along the line 6-6 of FIG. 5;

FIG. 7 is a perspective view illustrating how the trailer may be folded into a compact mode for storage;

FIG. 8 is a perspective view of a belt accessory which may be used in conjunction with the trailer of the present invention;

FIG. 9 is a side elevational view, partially exploded, illustrating use of a sled as a towed vehicle along with a modified interconnecting member;

FIG. 10 is a top view of a modified support;

FIG. 11 is a perspective view of the top portion of the sled of FIG. 9; and

FIG. 12 is a sectional view of an attachment device that may be used with the belt of FIG. 8.

### DESCRIPTION OF THE PREFERRED EMBODIMENTS

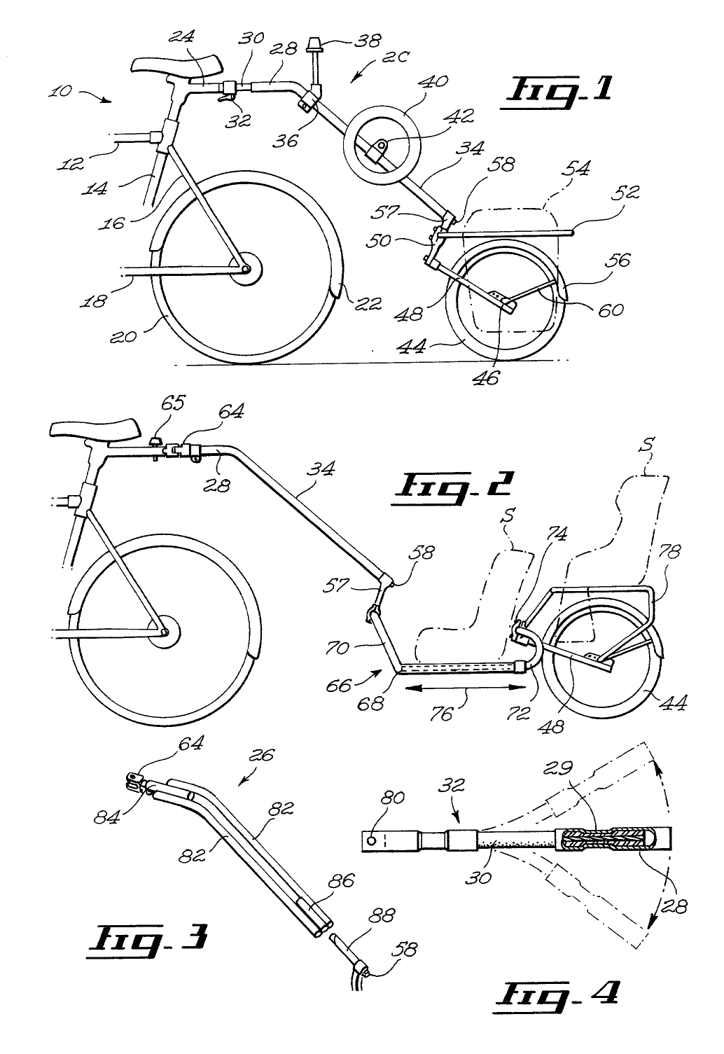

Referring to the drawings in greater detail, and by reference characters thereto, there is illustrated in FIG. 1 a portion of a bicycle 10 which includes a top tube 12, a seat tube 14 and a seat stay 16. Bicycle 10 also includes a conventional horizontal tube 18 with the rear wheel 20 having a fender 22 extending thereabout.

In the illustrated embodiment, there is provided a seat post 23 having a horizontal mounting member 24 extending rearwardly thereof. The trailer includes an interconnecting member generally designated by reference numeral 26 and which interconnecting member 26 has an upper portion 28 and a lower portion 34. Upper portion 28 is designed to be generally horizontal when connected to the bicycle. A connecting tube 30 is adapted to fit within mounting member 24 and be retained therein by means of a clamping device 32. It will be noted that the point of connection between connecting member 30 and horizontal projection 24 is generally in a vertical plane extending through the hub of rear wheel 20.

As may be best seen in FIG. 4, in one embodiment of the invention, connecting tube 30 is formed of a flexible material and may be retained by clamping as indicated by clamped portion 29. At its other end, connecting tube 30 has a portion with an aperture 80 extending therethrough to receive a locking pin (not shown).

As aforementioned, interconnecting member 26 also includes a lower portion 34. Mounted on an upper portion of lower portion 34 is a light 38 which is retained by means of clamp 42. Lower portion 34 may also include a further clamping member 42 for purposes of retaining a spare wheel 40.

The trailer is of the single wheel type and, as may be seen in FIG. 1, has a wheel 44 with a fender 56 extending partially thereabout. Mounted on axle 46 is a fork 48 as may be best seen in FIG. 6. Second connecting means include an interconnecting clamp member 50 which is secured to a baggage rack 52. Baggage rack 52 may be used to carry, as shown in the illustrated embodiment, saddle bags 54.

Third connecting means include interconnecting clamp member 57 which has a bolt 58 which is used to connect the same to lower portion 34 by means of an offset or a cam tightening device as is well known in the art. Fender 56 is secured to the axle 46 by means of an attachment 60.

FIG. 2 illustrates the insertion of an additional module between the interconnecting member and the vehicle. As will be the case with the subsequent embodiments, common reference numerals are used for common components.

As may be seen from FIG. 2, the upper portion 28 includes a universal joint 64 instead of connecting member 30. A safety pin 65 is used to ensure the security of the attachment of upper portion 28 to the seat post.

A second baggage carrying module generally designated by reference numeral 66 is inserted between the previously described rack and interconnecting member 26. Second baggage module 66 includes a lower baggage frame 68, an end baggage frame 70 and an opposed end baggage frame 72. End baggage frame 72 is secured by means of a clamp 74 while it will be noted that end baggage frame 72 is slidably mounted within lower baggage frame 68 in a telescopic arrangement as indicated by arrow 76 such that the size thereof may be adjusted. In this embodiment, a pair of child seats generally designated by reference numeral S may be mounted on each of the baggage modules.

As shown in FIG. 3, interconnecting member 26 may be reinforced by the provision of a pair of tubes 82 with a center tube 84 and 86 at either extremity thereof for connecting purposes. As shown therein, a cam type locking member 88 may be adjusted by means of bolt 58.

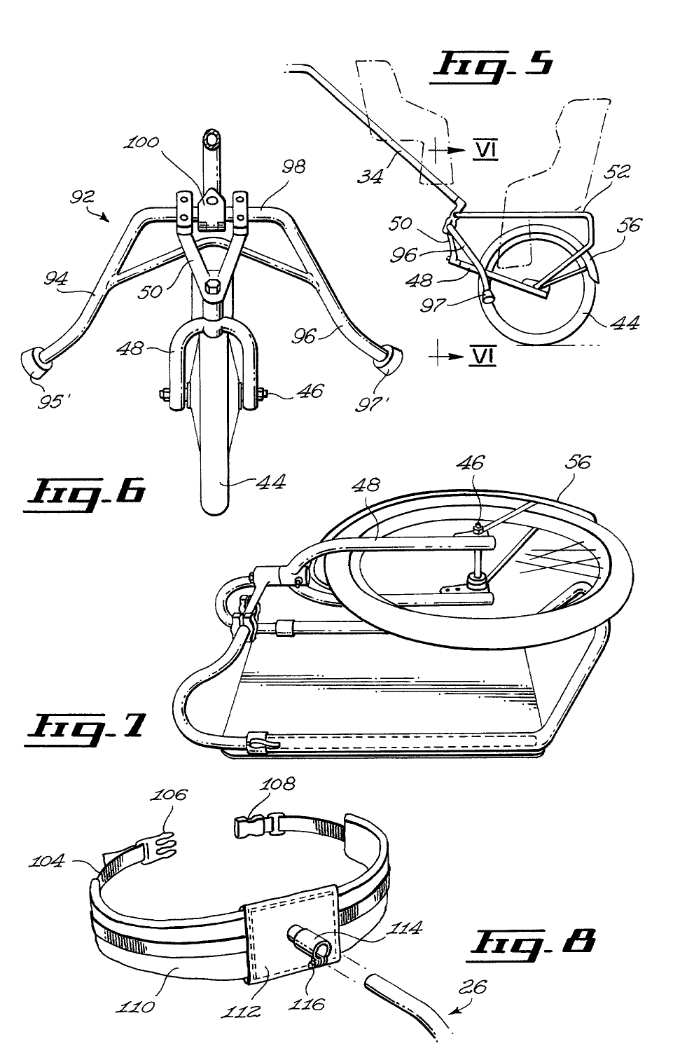

As is shown in FIGS. 5 and 6, there is provided a safety stand 92 which is comprised of a pair of legs 94 and 96 extending outwardly from horizontal frame 98. Pads 95 and 97 may be provided on the ends of legs 94 and 96 respectively. Safety stand 92 is retained by means of a clamp 100 on frame 98. In this arrangement, the safety stand will prevent the rear carrier from falling when in a stopped position.

As shown in phantom outline in FIG. 5, a second baby seat may be mounted in a rear facing mode on lower portion 34.

The trailer may be easily stored as is illustrated in FIG. 7. Folding is achieved by pivotal movement of the fork 48 with respect to baggage rack 52.

FIG. 8 illustrates an optional accessory comprised of a belt generally designated by reference numeral 104 which may be used to pull the trailer assembly. To this end, belt 104 includes clasps 106 and 108 for connecting the belt about the body of a wearer. Padding 110 is provided about a portion of belt 104 while a leather plate 112 is used for mounting a connector 114 to receive an end of the interconnecting member 26. A locking device 116 is provided to securely clamp the members together.

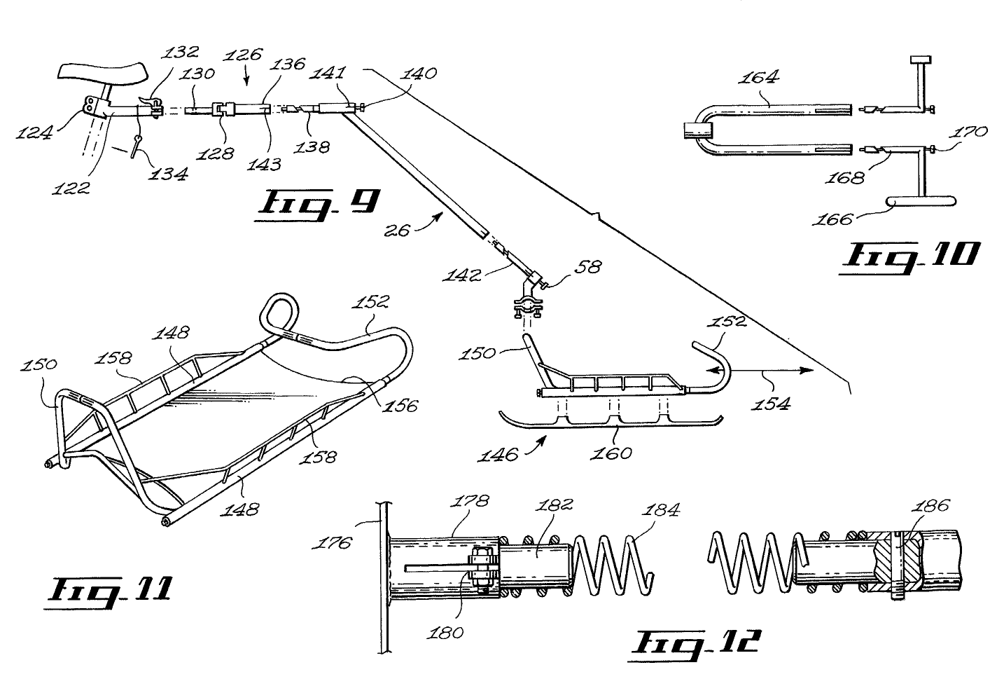

Turning to the embodiment of FIG. 9, there is provided a seat post attachment 122 having a pair of ears 124 to receive bolts or other means for securement to the seat post. There is provided a horizontal frame segment generally designated by reference numeral 126 having a first end portion 130 which is designed to fit within seat post attachment 122 and be secured thereto by means of a clamp 132. A locking pin 134 may extend through an aperture in first end portion 130 and a corresponding portion of seat post attachment 122. Second end portion 136 is designed to receive a cam action locking device 138 which is adjusted by means of bolt 140. An indicating line 141 is lined up with line 143 on second end portion 136 to ensure the proper connection.

The lower end of interconnecting member 26 also includes a cam action locking device 142 which is activated by means of bolt 58.

In the illustrated embodiment, there is provided a sled component 146 having a pair of side frame members 148, an end frame member 150 and a second end frame member 152. In this respect, sled component 146 is similar to baggage module 66 illustrated in FIG. 2. Thus, end frame member 152 is slidably engaged within side frame members 148 as indicated by arrow 154 to permit a telescopic movement. Mounted between side frame members 148 is a base 156 while side guards 158 may be mounted on side frame members 148. The arrangement is such that sled 146 may be mounted on runners 160.

Illustrated in FIG. 10 is an arrangement wherein, in one embodiment, there is provided a set of safety wheels 166 (only one wheel shown) which may be utilized particularly when a baby seat is mounted on the luggage rack. In this embodiment, there is provided a fork 164 which is adapted to receive cam action locking devices 168 activated by bolts 170. Wheels 166 would be mounted thereon and would be arranged to contact the ground when required. The arrangement for the safety wheels is particularly desirable when the trailer is pulled by a person utilizing the belt illustrated in FIG. 8. In this case, the small wheels 166 would be mounted on either side to help maintain the trailer portion in the vertical position. When used by the cyclist, one may use the protective safety stand 92 when, as shown in FIGS. 5 and 6, the baggage stand and associated attachment 50 is utilized.

A somewhat different version of the attachment shown in FIG. 8 is illustrated in FIG. 12. In this arrangement, a plate 176 goes between member 112 and has a tube 178 welded thereto. Mounted internally is a nut and bolt arrangement 180 designed to receive one end of a spring member 184 which surrounds a portion of an inner tube 182. Spring 184 functions as a type of universal joint and is secured at both ends. A screw 186 is provided for locking member 182 in position.

It will be understood that the above described embodiments are for purposes of illustration only and that changes and modifications may be made thereto without departing from the spirit and scope of the invention.

I claim:

1. A trailer assembly connectable to a bicycle having front and rear wheels and having a seat mounted on a seat post, said trailer assembly comprising:
a frame having an upper portion and a lower portion;
a rearwardly extending member secured to said seat post;
first connecting means connecting said upper portion to said rearwardly extending member, said first connecting means permitting movement in both a longitudinal and a horizontal plane, said first connecting means being located proximate a vertical plane extending through a hub of said rear wheel;
a trailer, said trailer having an axle, a single wheel and a fork connected to said axle on either side of said wheel;
baggage carrying means, said baggage carrying means comprising a baggage carrying frame, second connecting means extending between and connecting said baggage carrying frame and said fork, said second connecting means permitting rotatable movement between said baggage carrying frame and said fork such that said baggage carrying frame can be moved to a storage position; and
third connecting means extending between and connecting said lower portion and said baggage carrying frame.

2. The trailer assembly of claim 1 wherein said baggage carrying means includes saddle bags mounted thereon.

3. The trailer assembly of claim 1 wherein said baggage carrying means includes a child seat mounted thereon.

4. The trailer assembly of claim 1 wherein said first connecting means include a universal joint to permit said movement in both horizontal and vertical planes.

5. The trailer assembly of claim 1 wherein said first connecting means include a flexible member to permit said movement in both said horizontal and vertical planes.

6. The trailer assembly of claim 1 wherein said lower portion includes means for mounting a spare wheel thereon.

7. The trailer assembly of claim 1 further including second baggage carrying means, said second baggage carrying means being interposed between said first baggage carrying means and said lower portion and being connected thereto.

8. The trailer assembly of claim 7 wherein said second baggage carrying means further include means for carrying a child seat thereon.

9. The trailer assembly of claim 1 further including first and second members extending outwardly from either side of said axle to act as a stand when said trailer is stopped.

10. The trailer assembly of claim 1 further including first and second side safety wheels connected to either side of said axle.
